(19) United States
(12) Patent Application Publication
(10) Pub. No.: US 2006/0204045 A1
(43) Pub. Date: Sep. 14, 2006

(54) System and method for motion performance improvement

(76) Inventor: Paul Robert Angelo Antonucci, Watertown, MA (US)

Correspondence Address: AKC PATENTS, 215 GROVE ST., NEWTON, MA, 02466, US

(21) Appl. No.: 11/364,974

(22) Filed: Mar. 1, 2006

Related U.S. Application Data
(63) Continuation-in-part of application No. 11/135,577, filed on May 23, 2005.
(60) Provisional application No. 60/575,031, filed on May 27, 2004.

(51) Int. Cl. G06K 9/00; G09G 5/00

(52) U.S. Cl. 382/107; 382/103; 345/156

(57) ABSTRACT

A system for improving performance and reducing injuries due to improper body mechanics in sports such as baseball, football, and tennis includes equipment for capturing visual images of the person's physical motion over time and a computing device for receiving these visual images and converting them into a graphical representation of the person's physical motion. The system also compares and displays this graphical representation of the person's physical motion with a graphical representation of an ideal standard of the same physical motion in real time on a display screen and provides real time feedback instructions to the person for improving the physical motion performance based on the comparison results.

### CROSS REFERENCE TO RELATED CO-PENDING APPLICATIONS

This application claims the benefit of U.S. provisional application Ser. No. 60/658,833 filed on Mar. 4, 2005 and entitled SYSTEM AND METHOD FOR SPORTS PERFORMANCE IMPROVEMENT which is commonly assigned and the contents of which are expressly incorporated herein by reference.

This application is also a continuation in part and claims the priority benefit of U.S. application Ser. No. 11/135,577, filed on May 23, 2005, and entitled “SYSTEM AND METHOD FOR MOTION VISUALIZER”, the contents of which application are expressly incorporated herein by reference.

### FIELD OF THE INVENTION

The present invention relates to system and a method for motion performance improvement, and more particularly to a system and a method for motion performance improvement that provides real-time sensory feedback.

### BACKGROUND OF THE INVENTION

Large numbers of people are involved in youth and amateur sports. For example, baseball alone, one of the most popular sports in the United States has an estimated 4.8 million boys and girls 5 to 14 years of age participating annually in organized and recreational baseball and softball. Unfortunately, far too many of these children are not being taught proper throwing mechanics and are being pushed for competitive results, leading to arm injuries that are often serious. The injury numbers here are not small. A recent survey of 172 9- to 12-year old pitchers who were followed for a year had an incidence of injury of 40%. One problem is now so common that it is called “Little League Elbow”, and the leagues have instituted pitch count limitations. In medical terms, “Little League Elbow” refers to medial elbow pain attributable to throwing by skeletally immature athletes. Pitchers are most likely to be affected by this condition, but it can occur in other positions associated with frequent and forceful throwing. The throwing motion creates traction forces on the medial portion of the elbow and compression forces on the lateral portion of the elbow. (PEDIATRICS Vol. 107 No. 4 April 2001, pp. 782-784)

Knowledgeable instruction on proper pitching mechanics is one of the most important elements to preventing serious throwing injuries in young ballplayers. This instruction is necessary because the pitching motion is unnatural. According to sports medicine experts at Georgetown University Medical Center, the combined windup, leg kick, delivery and follow-through of the typical baseball pitcher is a feat of biomechanics that's downright unnatural. Throwing with intensity, speed and control is absolutely an acquired skill. Researchers at Johns Hopkins University describe the forces involved as equivalent to someone trying to dislocate pitchers' shoulders.

At the moment there is no affordable, commercially available interactive computer-based pitching program available. There are a few expensive high-end motion analysis systems that are used by researchers and professional athletes. These systems are used by professionals who interpret the data and provide cognitive feedback and analysis to professional athletes. However, these high-end systems do not provide real-time sensory feedback concerning selected physical parameters and are not used to train amateurs. While computers and modern technology have been used to advantage in professional sports, they are not extensively used in amateur or recreational contexts. There is clearly a great need and opportunity for a tool for improving the mechanics and safety of sports.

There are presently three systems available that a parent or coach can use to help train young pitchers. In two systems, the parent/coach tapes the pitcher then sends the tape in to be analyzed. The cost of one such analysis, by Virtual Sports Imaging of Marietta, Ga., is $199.00 for an analysis of a pitcher's throwing motion (including full kinematics feedback). Youth Pitcher (www.youthpitcher.com) charges $39.99 for a frame-by-frame video analysis only. Also available is a facility in San Diego in which a young pitcher may have sensors strapped on and pitch while the motion is monitored by 8 video cameras. Again, the analysis is delayed, and the cost is $400 per session. These systems, unlike the system we propose, are not based on real-time motion detection, and are not based on any sort of kinesthetic feedback, but on data being analyzed and cognitively presented. There is a tremendous gap in the connection with learning due to the lack of instant feedback and interaction with what is happening at the moment.

Another form of technology that is available commercially is radar guns that report the speed of a throw. This technology is no doubt destructive in its impact, as it encourages faster throwing (push for completive result), directly in contradiction to what young athletes should focus on (proper throwing mechanics).

### SUMMARY OF THE INVENTION

In general, in one aspect, the invention features a system for improving a person's physical motion performance. The system includes a first equipment for capturing a first set of visual images of the person's physical motion over time and a computing device for receiving a signal of the first set of visual images of the person's physical motion and converting the first set of visual images into a graphical representation of the person's physical motion and displaying the graphical representation on a display screen in real time with the capturing of the first set of visual images. The system also includes means for comparing the graphical representation of the person's physical motion with a graphical representation of an ideal standard of the physical motion in real time on the display screen, means for displaying results of the comparison on the display screen and means for providing real time feedback instructions to the person for improving the physical motion performance based on the comparison results.

Implementations of this aspect of the invention may include one or more of the following features. The person's physical motion may be whole body motion, motion of a body member or motion of a group of body members. The system may further include an electronic sensor that is attached to a moving body member of the person, captures motion parameters of the moving body member and transmits the motion parameters to the computing device. The electronic sensor may be an accelerometer, RF-sensor, active optical sensor, passive optical sensor, or magnetic sensor. The real time feedback may be spoken words and sentences or sound with varying pitch and volume. The graphical representation of the object's motion comprises a position coordinate graph, or a position versus time graph or a position graph overlaid onto a live video image. The system may further include a second equipment for capturing a second set of visual images of the object's motion over the time. In this case, the computing device receives a signal of the second set of visual images and combines the second set visual image signal with the first set visual image signal and converts the combined first set and second set visual image signals into a graphical representation of the object's motion and displays the graphical representation on the display screen in real time with the capturing of the first set and second set of visual images. In this case the graphical representation comprises a three-dimensional position coordinate graph. The computing device converts the combined first set and second set of visual image signals into a graphical representation of the object's motion via triangulation. The first and the second equipment comprise a first and a second optical axis, respectively, and are arranged so that their corresponding first and second optical axes are at a known angle and the first and the second equipment are equidistant from the first and the second optical axes' intersection point. The three-dimensional position coordinate graph comprises the object's position coordinates plotted in a three-dimensional x-y-z Cartesian coordinate system. The x-y-z Cartesian coordinate system comprises an origin located at the intersection point of the first and the second optical axes, an x-axis running parallel to a line joining the first and the second equipment, a y-axis running perpendicular to the line joining the first and the second equipment directly between the first and the second capturing equipment and a z-axis running vertical through the origin. The length of the line joining the first and the second equipment is used to scale and calculate the position coordinates in true distance units. The system may further include a video controller for receiving a signal of the first set of visual images, locating the object and transmitting a signal of the object's location to the computing device. The object includes a bright color and the video controller locates the object in the first set of visual images based on the bright color exceeding a set threshold level of brightness. The signal of the object's location includes average x-pixel position, average y-pixel position, object average height, and object average width. The computing device may further include an object locating algorithm for receiving the signal and locating the object. Again, the object may have a bright color and the object locating algorithm may locate the object'position coordinate data in the first set of visual images based on the bright color exceeding a set threshold level of brightness. The first set of visual images comprise motions of more than one objects. The first set of visual images may be captured at a frequency of 30 times per second. The first set and the second set of visual images are captured at a frequency of 30 times per second each and the computing device receives interlaced images of the first set and the second set of visual images at a frequency of 60 times per second. The first capturing equipment may be a video camera, a video recorder, a NTSC camcorder or a PAL camcorder. The graphical representation of the object's motion may be a velocity versus time graph or an acceleration versus time graph. The object's position coordinate data are smoothed to correct for small and random errors via an algorithm that fits a parabola to an odd number of adjacent position coordinate data using a least-squares method. The object's position coordinate data are filtered using filters selected from a group consisting of a minimum object size filter, a debounce horizontal filter, a debounce vertical filter, and an object overlap filter. The computing device may be a personal computer, a notebook computer, a server, a computing circuit, or a personal digital assistant (PDA). The means for comparing comprise an application program that displays simultaneously the physical motion graphical representation and the ideal standard of the physical motion and computes deviations between the physical motion graphical representation and the ideal standard of the physical motion. The means for providing real-time feedback include audible feedback, visual feedback or other sensory feedback. The physical motion may be sport exercises, physical therapy exercises, motion analysis exercises, dance exercises, musical training exercises, therapeutic exercises or diagnostic exercises. The system may further include a training program for the exercises. In general, in another aspect, the invention features a method for improving a person's physical motion performance including first capturing a first set of visual images of the person's physical motion over time with a first equipment; next, receiving a signal of the first set of visual images of the person's physical motion by a computing device and converting the first set of visual images into a graphical representation of the person's physical motion and displays the graphical representation on a display screen in real time with the capturing of the first set of visual images; next, comparing the graphical representation of the person's physical motion with a graphical representation of an ideal standard of the physical motion in real time on the display screen and displaying results of the comparison on the display screen; and finally, providing real time feedback instructions to the person for improving the physical motion performance based on the comparison results.

Among the advantages of this invention may be one or more of the following. The motion improvement system builds on the learning theory of real-time feedback combined with inexpensive data collection technologies—ordinary video cameras, wireless accelerometers, personal computers, and computer generated sounds. This makes it an ideal learning tool for a wide audience and puts it within the financial and technical reach of organizations devoted to the development of student-age players. This system utilizes the effectiveness of real-time auditory feedback of motion variables (with and without visual feedback on a computer screen), an area that is highly under-explored, and, we feel, has huge potential to leverage learning through human-computer interactions. A system that is successful in baseball can be adapted to other sports as well, such as football, basketball, tennis, hockey, golf, gymnastics, among others. Given the sensory feedback, it may also be applicable for therapeutic and diagnostic purposes for motion disorders, especially for cognitively impaired individuals.

### BRIEF DESCRIPTION OF THE DRAWINGS

Referring to the figures, wherein like numerals represent like parts throughout the several views:

FIG. 1 is a schematic diagram of the sports performance improvement system of this invention;

FIG. 2 is a schematic diagram of the hardware and software components of the system of FIG. 1;

FIG. 3 is a graph displaying a dip in the arc of the overhand motion during baseball pitching;

FIG. 4 is a graph displaying the “leading with the elbow” problem in the motion of the pitcher's wrist 86 and elbow 84, during a pitch where the motion is from left to right;

FIG. 5 is a graph displaying the same motion as in FIG. 4 but the pitch is more fundamentally sound with the elbow being behind the wrist at the apex;

FIG. 6 is a schematic diagram of a self-contained feedback providing sensor; and

FIG. 7 is a visual display of a player throwing a ball, the path of the actual motion of the throwing hand and the path of an ideal motion of the throwing hand.

### DETAILED DESCRIPTION OF THE INVENTION

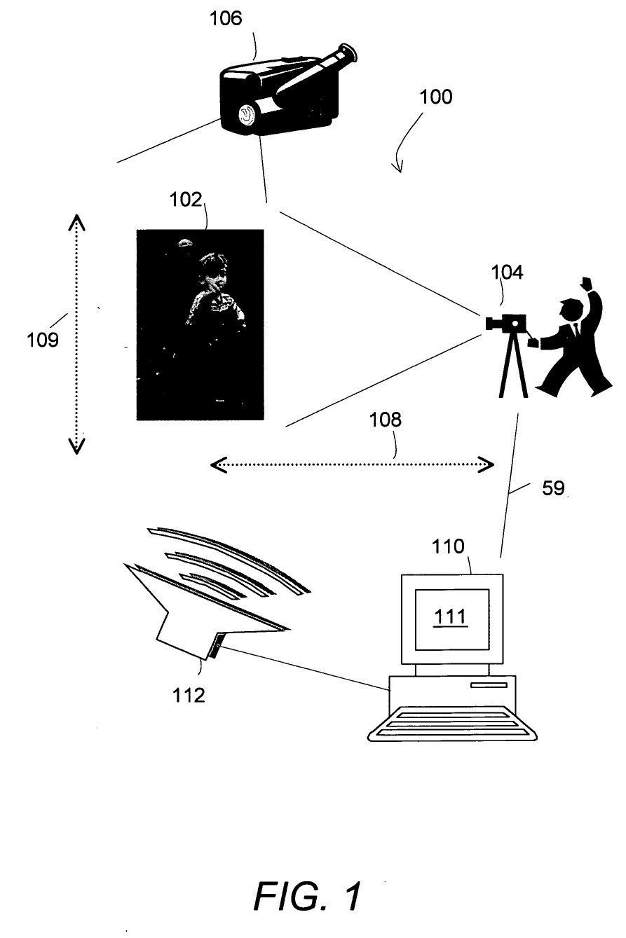

Referring to FIG. 1, a sports performance improvement system 100 includes first and second video cameras 104, 106, respectively, for recording the real time body motion of the athlete 102. A computer system 110 receives the video and audio input from the cameras 104, 106, processes the input data, and displays them as a graphical output on the computer screen 111. The computer system 110 compares the graphical representation of the motion with a previously recorded and stored ideal standard of the same motion and evaluates the differences between the two graphs in real time. Based on the results of this real-time comparison the system provides audible feedback to the athlete 102 via a speaker 112. In one example, the video camera 104 is set at a distance 108 of about 12 feet from the athlete 102 and the viewing field has a radius 109 of about 5 feet, i.e., high enough to capture the body motion of a young athlete. Various points on the body of the young athlete 102 are marked with brightly colored tags and the motion of the brightly colored tags is tracked by the video cameras 104, 106. Typical points that are marked include the elbow and wrist of the throwing hand, shoulders, knees, hips and waist. In addition to points on the athlete's body, other items that are marked include the ball, the glove, or the bat. The brightly colored tags may be self-adhesive tape, bands, colored clothing, patches that are stitched, pinned, or glued onto clothing, colored gloves or vests. In other embodiments electronic sensors are incorporated in the moving body parts or other the moving items. These electronic sensors include accelerometers, RF-sensors, active or passive optical sensors, or magnetic sensors. The method of tracking and analyzing the motion of a brightly colored tag is described in a co-pending patent application Ser. No. 11/135,577, the contents of which are incorporated herein by reference.

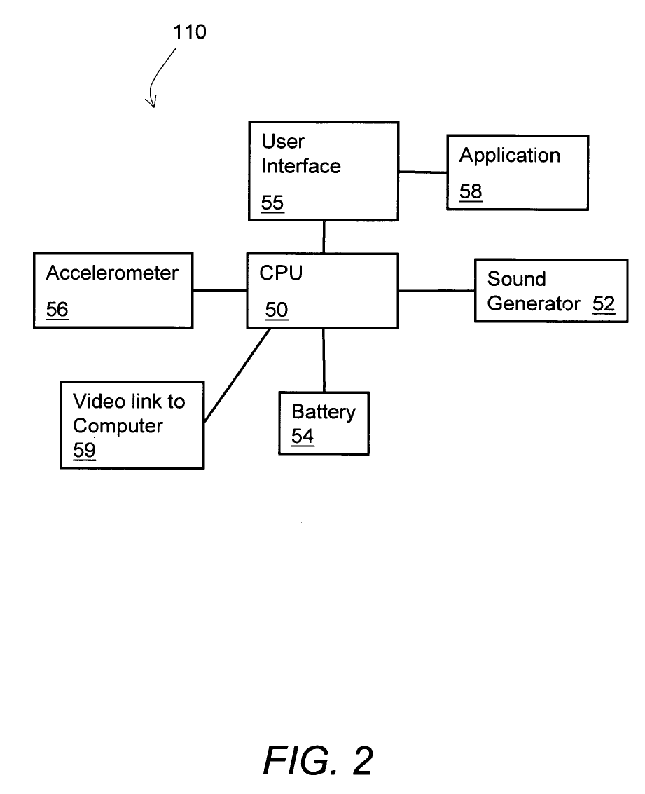

Referring to FIG. 2, the computer system 110 includes a CPU 50 that receives and processes the video input 59 from the cameras 104, 106. In embodiments that utilize sensors such as accelerometers 56, the CPU 50 receives input from these sensors either through a wired or a wireless connection. A computer application 58 evaluates and graphs the input data and displays them on the computed screen. In addition to the graphical representation of the data, the application 58 compares the graphical representation of the motion with a previously recorded and stored ideal standard of the same motion and evaluates the differences between the two graphs in real time. Based on the results of this real-time comparison the system provides audible feedback to the athlete 102 and his coach via a speaker 112 or another sound generating chip 52. The sound feedback may be spoken words or a sound with varying pitch and volume. In one example, the CPU is a Microchip PIC16F876A, the sound generator 52 is a speaker and an ICM 8038, and the accelerometer 56 is an analog device ADXL320. One video camera 104 is sufficient for tracking the motion of the colored tags. However, more than one or two video cameras may be used for three dimensional representation and better resolution. The motion parameters that are being tracked include three dimensional position, speed and acceleration coordinates, rotational angle, speed and acceleration and parameters such as distance of the ball thrown, environmental conditions and wind speed. The computing device 110 may be a personal computer, a notebook computer, a server, a computing circuit, or a personal digital assistant (PDA).

The User Interface 55 of the application 58 displays the motion trajectory and highlights the moving tags that are being tracked. It displays the motion data in real-time as the athlete throws the ball. It also provides the option of comparing the actual motion with a stored ideal motion and provides feedback based on the observed deviations. The feedback contains messages that aim to prevent injuries, provide training exercises and develop and follow a training curriculum.

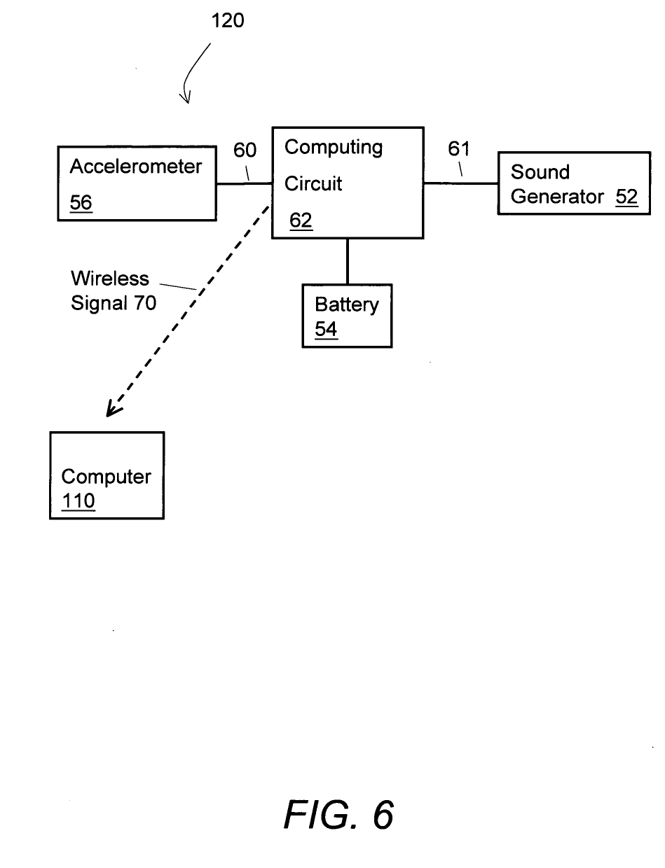

In another embodiment, a self-contained system 120 provides both the sensor signal and the audible feedback signal. Referring to FIG. 6, the self-contained system 120 includes a sensor 56, a computing circuit 62 and a sound generator 52. In one example, system 120 is a one inch by one inch square device that can be attached on the athlete's wrist via a Velcro band. In this example, sensor 56 is an accelerometer that measures the acceleration and angular position of the athlete's wrist and transmits the measurement signal 60 to the computing circuit 62. The computing circuit 62 receives the measurement signal 60, computes the position and velocity of the athlete's wrist and sends a signal 61 to the sound generator 52. The sound generator 52 receives the signal 61 from the computing circuit 62 and generates a sound that has a pitch proportional to the velocity of the athlete's wrist. The signal 61 may also be wirelessly transmitted to the computer system 110 of FIG. 1.

The nature of the real-time human-computer interaction of this invention is transformative for the athlete as it provides a direct link between action and representation. It stands in contrast to many other sports improvement tools where performance “data” are recorded and presented after a delay to the athlete. For this approach to be effective the athlete must know how to correct the motion, but the “feeling” part of the motion—the connection between the kinesthetic sensation and the representation—has been lost in the delay. In many cases, as described below, less experienced athletes are not aware of what their arms and shoulders are doing, so a delayed presentation of data, or even a coach's verbal instruction “elbow higher!” is not effective. The young athlete in particular may think “there, I have it higher”, but the reality may be completely different. Real-time presentation of data forges a much tighter bond between cause and effect.

The belief that real-time systems provide more effective learning than delayed representation systems is based on the educational research of Microcomputer Based Labs (MBL) that begun in the mid-1980's. Brassel, in particular, highlighted the importance of the simultaneity of the sensed quantity and its representation to learning, and numerous other studies have confirmed its importance. (Brasell, H. (1987). The Effect of Real-Time Laboratory Graphing on Learning Graphic Representations of Distance and Velocity. Journal of Research in Science Teaching, 24(4), 385-395.) (Thornton, R. K., & Sokoloff, D. R. (1990). Learning Motion Concepts Using Real-Time Microcomputer-Based Laboratory Tools. American Journal of Physics, 58(9), 858-867. Beichner, R. 1990 The effect of simultaneous motion presentation and graph generation in a kinematics lab. Journal of Research in Science Teaching 27: 803-815. However, other types of systems also indicate the power of this approach. For instance, this same methodology is the basis of biofeedback, in which even involuntary muscles can be brought under conscious control when “tapped” by physiological sensors and represented back to the user in real-time. With this system, players get real-time sensory feedback on selected aspects of their body's muscles motions, for instance, the speed of the arm, or the angle of the elbow.

Relatively inexpensive sensors are crucial to the system. The system utilizes the motion tracking technologies described in the co-pending patent application Ser. No. 11/135,577 that uses ordinary video cameras as the main motion sensors. Our scheme uses a brightly colored “target” to identify the tracking points. With one video camera, motion in a well-defined plane can be tracked. With two cameras, motion in three-dimensional space can be tracked and plotted on the three-dimensional computer based graph that can be turned and viewed from any perspective. There are several limitations with video based motion sensing. First, if the target goes out of the camera's view briefly such as when it is “eclipsed” by another part of the body, there is a “hole” in the data. Second, ordinary video cameras are limited to a data rate of 60 Hz (using interlaced fields of NTSC video). Many interesting sports motions happen very quickly and require a faster data rate in order to be captured correctly and in sufficient detail. The video-based motion system is augmented with accelerometers—sensors that can be used to track motion. Accelerometers have the advantage that they never go out of view and can be run a high data rates. The accelerometers are small, can be relatively inexpensive, and made to send their data via a wireless link and are hence ideal for sports use. Their cost is vastly less than high speed video cameras which are not an option for an inexpensive system.

The use of sound to represent a data set (sonification) is an on-going branch of research supporting several international organizations and professional societies. Of prime interest is the application of this research to adaptive technologies (AT) to make scientific data accessible to the blind and seeing-impaired by “mapping” certain data variables to pitch, volume, or timbre, for instance, and playing them over time. The present system provides immediate visual and auditory feedback to a user, determines performance requirements, improves performance and reduces injuries in Little League participants.

Potential benefits of using this technology include 1) reduction in injuries that are due to improper body mechanics, 2) better athletic performance, 3) increased scientific and technological literacy to the target population of sports enthusiasts, 4) increased scientific understanding of the use of sonification to represent motion in the human-computer interaction. We believe that the target population of sports oriented youth is an ideal group to approach with the goal of improving science and technology literacy. The connections between science and sports are many and user of our system will see the relevance of that science and technology to their own lives. The target population can learn both some of the scientific principles of physiology (e.g. what causes injury, or what gives speed), and the physical science of forces and motion (e.g. the difference between “speed” and “velocity”, or the representation of space as different components.)

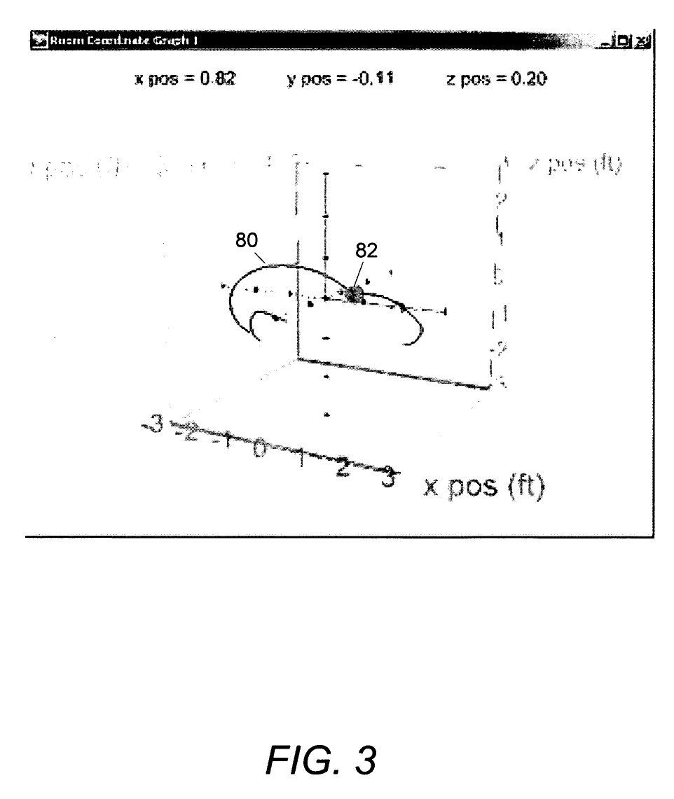

In our work with high-school aged students, we found that many students were motivated to learn physics because our technology allowed them to study physics in contexts that were meaningful to them and fun for them: for example sports, games, toys, and gymnastics. We learned much about the complexities of pitching and common problems through working with the kids. One common problem with young pitchers is the inability to put together one smooth, continuous motion. We often see a hesitation and/or a dip in the arc of an overhand motion as the player tries to imitate the windup of a big league pitcher, as shown in FIG. 3. One nine year old player went through the season listening to the coaches talk about “a full, round motion” yet his throwing didn't improve until after the season, when he worked with this system. When the system of this invention was set up, Alex seemed fascinated with watching the screen and moving his arm, as he finally realized that what he thought his arm was doing, was not what his arm was actually doing. This was similar to what we have observed in physics and mathematics classrooms, where students are fascinated to watch (for example) graphs of X, Y, and Z coordinates or velocities while they move their arms in various directions, finally sorting out, for example, that “Z velocity” can be zero or negative when an object is moving rapidly in X or Y.

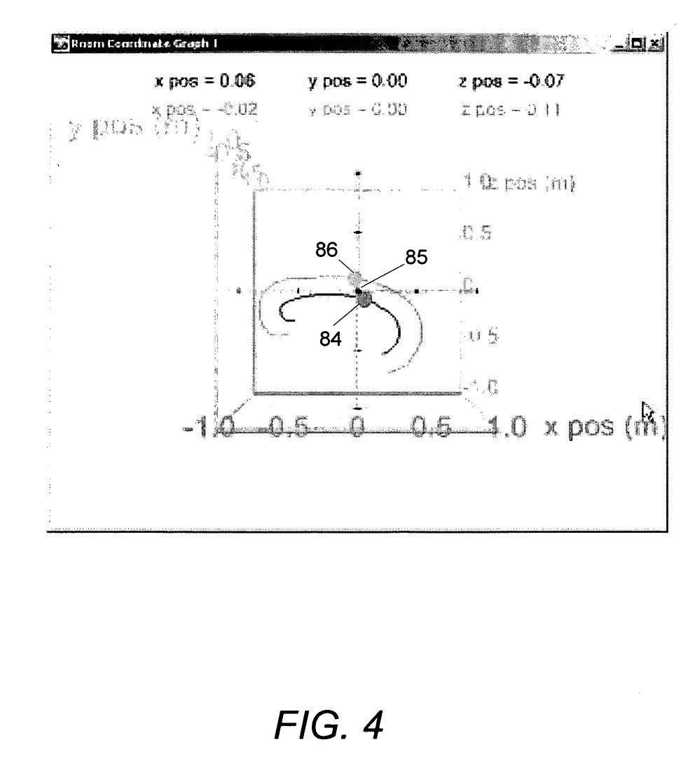

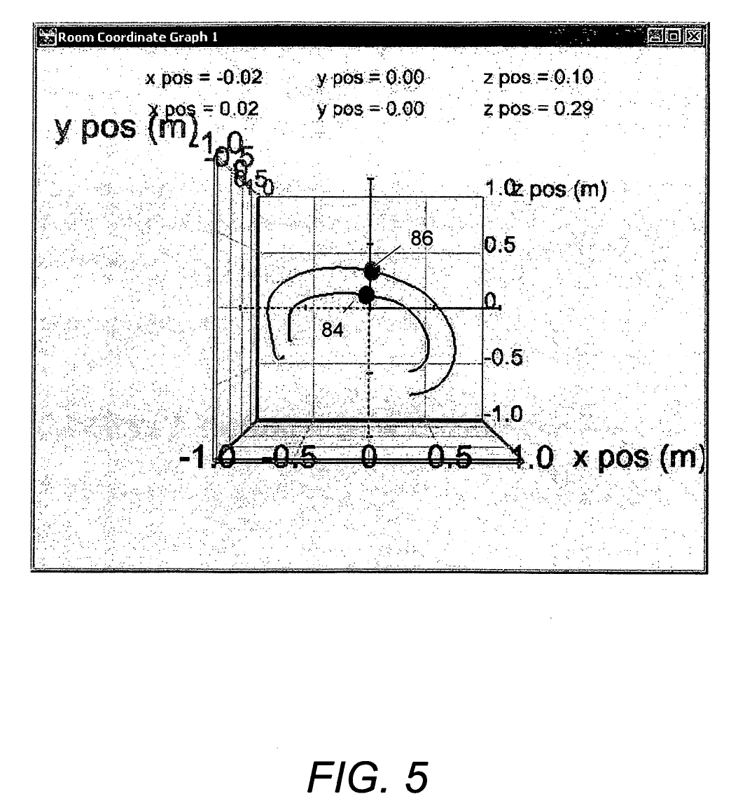

Another common problem is players “leading with the elbow” when moving their arm forward to throw. Referring to FIG. 4, the motion of the pitcher's elbow 84 and the motion of the pitcher's wrist 86 is tracked during a pitch throw. We observe that the elbow 84 which connects to the wrist 86 via line 85 leads in this motion where the arm moves from left to right on the screen. Line 85 marks the orientation of the pitcher's forearm. FIG. 5 depicts the same motion of the elbow and wrist in a more fundamentally sound pitch throw with the elbow 84 being behind the wrist 86 at the apex.

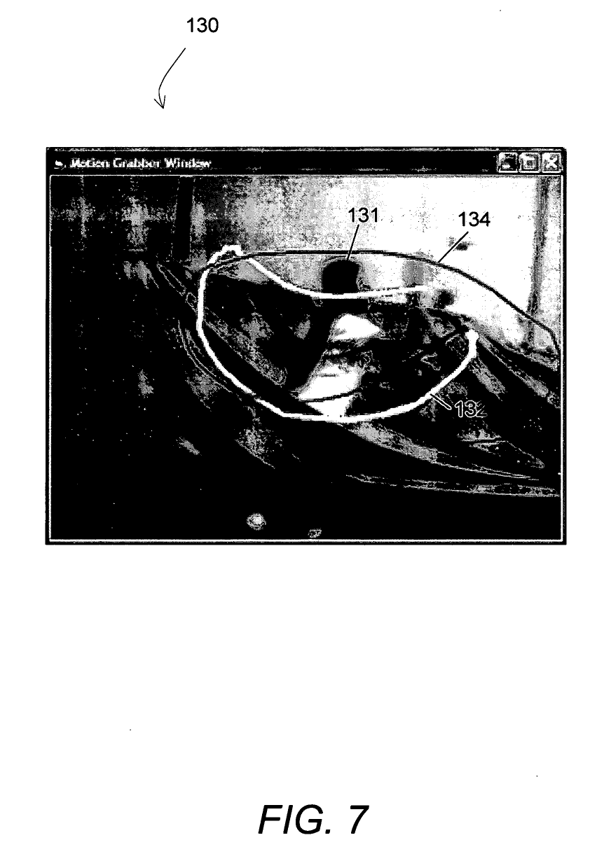

Referring to FIG. 7, in the still frame 130 above from the field-trial, the throwing hand of the player 130 marked, with an orange glove, is being tracked. The actual path of the hand is represented by curve 132 and is overlaid onto the reference motion curve 134 made earlier by the coach. These motions 132 and 134 can also be displayed side-by-side. The player's “dip of the elbow” as the hand starts to come forward, a common problem, can easily be seen. In another example, a graph of the distance from the waist to the elbow during pitching is displayed to determine if the elbow is dropping while the arm is coming forward in the pitching movement. Audio and visual feedback are used to alert the player to specific problems. The players do not try to match every point on the expert's curve, but to match the overall shape. All of the players understand this quite easily. It is very difficult, especially for young players, to interpret words and shape them into a refined physical movement. The player is initially unaware of his or her problem, so a coach's verbal instruction such as, “As your hand comes forward, don't let it drop down,” is hard for most children to translate into a new motion. In contrast, when there is a direct feedback path between the eye, arm, and hand, change occurs much more quickly. It needs no verbal translation. Our real-time, sensory feedback lets players see what they are doing while practicing a throw, correct it, and feel it at the same time. It is this immediate connection between seeing and feeling a motion that produces the ability for young players to change and improve. This is the essence of kinesthetic learning.

In other embodiments the system 100 is used to monitor and improve a person's physical motion during a set of physical therapy exercises, motion analysis exercises such as gait analysis, dance exercises, musical training exercises, therapeutic exercises and diagnostic exercises. Computerized devices that augment a physical therapy program and monitor patient's activities and physical motions are invaluable to doctors and patients because of the feedback they provide. System 100 not only replaces some of the physical therapist's functions such as advising and instructing the patient and advising the attending physician of patient outcome and compliance, but also allows an improved quantitative measuring and monitoring of patient rehabilitation activities and exercise parameters, such as effort exerted in rehabilitation exercises or stress applied to the orthopedic injury. These systems may also be used for healthy individuals as part of their exercise training routine. System 100 may also store specific therapeutic treatment exercise protocols or other training programs that the patient or the physical therapist may retrieve and apply. The real time feedback may be used to apply real time intervention in case where injury may result.

Several embodiments of the present invention have been described. Nevertheless, it will be understood that various modifications may be made without departing from the spirit and scope of the invention. Accordingly, other embodiments are within the scope of the following claims.

What is claimed is:

1. A system for improving a person's physical motion performance comprising:
a first equipment for capturing a first set of visual images of said person's physical motion over time;
a computing device for receiving a signal of said first set of visual images of said person's physical motion, converting said first set of visual images into a graphical representation of said person's physical motion and displaying said graphical representation on a display screen in real time with said capturing of said first set of visual images;
means for comparing said graphical representation of said person's physical motion with a graphical representation of an ideal standard of said physical motion in real time on said display screen and means for displaying results of said comparison on said display screen; and
means for providing real time feedback instructions to said person for improving said physical motion performance based on said comparison results.

2. The system of claim 1 wherein said person's physical motion is selected from a group of physical motions consisting of whole body motion, motion of a body member and motion of a group of body members.

3. The system of claim 1 further comprising an electronic sensor, wherein said electronic sensor is attached to a moving body member of said person, captures motion parameters of said moving body member and transmits said motion parameters to said computing device.

4. The system of claim 3 wherein said electronic sensor is selected from a group consisting of accelerometers, RF-sensors, active optical sensors, passive optical sensors, and magnetic sensors.

5. The system of claim 1 wherein said real time feedback is selected from a group consisting of spoken words and sentences and sound with varying pitch and volume.

6. The system of claim 1 wherein said graphical representation of said person's physical motion is selected from a group consisting of a position coordinate graph, a position versus said time graph, a three-dimensional position coordinate graph, a velocity versus time graph, an acceleration versus time graph and a position graph overlaid onto a live video image.

7. The system of claim 1 further comprising a second equipment for capturing a second set of visual images of said person's physical motion over said time and wherein said computing device receives a signal of said second set of visual images and combines said second set visual image signal with said first set visual image signal and converts said combined first set and second set visual image signals into a graphical representation of said person's physical motion and displays said graphical representation on said display screen in real time with said capturing of said first set and second set of visual images.

8. The system of claim 7 wherein said computing device converts said combined first set and second set visual image signals into a graphical representation of said person's physical motion via triangulation.

9. The system of claim 8 wherein said first and said second equipment comprise a first and a second optical axis, respectively, and are arranged so that their corresponding first and second optical axes are at a known angle and said first and said second equipment are equidistant from said first and said second optical axes' intersection point.

10. The system of claim 9 wherein a three dimensional position coordinate graph comprises position coordinates of tracking points positioned on said person plotted in a three dimensional x-y-z Cartesian coordinate system and wherein said x-y-z Cartesian coordinate system comprises an origin located at said intersection point of said first and said second optical axes, an x-axis running parallel to a line joining said first and said second equipment, a y-axis running perpendicular to said line joining said first and said second equipment directly between said first and said second capturing equipment and a z-axis running vertical through said origin.

11. The system of claim 10 wherein the length of said line joining said first and said second equipment is used to scale and calculate said position coordinates in true distance units.

12. The system of claim 1 further comprising a video controller for receiving a signal of said first set of visual images, locating tracking points on said person and transmitting signals of said tracking points locations to said computing device.

13. The system of claim 12 wherein said tracking points on said person comprise a bright color and said video controller locates said tracking points locations in said first set of visual images based on said bright color exceeding a set threshold level of brightness.

14. The system of claim 12 wherein said signals of said tracking points locations comprise average x-pixel position, average y-pixel position, average height, and average width.

15. The system of claim 12 wherein said computing device further comprises a tracking point locating algorithm for receiving said signal and locating said tracking points locations.

16. The system of claim 1 wherein said first set of visual images comprise motions of more than one person.

17. The system of claim 1 wherein said first capturing equipment is selected from a group consisting of a video camera, a video recorder, a NTSC camcorder, and a PAL camcorder.

18. The system of claim 1 wherein said computing device is selected from a group consisting of a personal computer, a notebook computer, a server, a computing circuit, and a personal digital assistant (PDA).

19. The system of claim 1 wherein said means for comparing comprise an application that displays simultaneously said physical motion graphical representation and said ideal standard of said physical motion and computes deviations between said physical motion graphical representation and said ideal standard of said physical motion.

20. The system of claim 1 wherein said means for providing real-time feedback are selected from a group consisting of audible feedback, visual feedback and sensory feedback.

21. The system of claim 1 wherein said physical motion is selected from a group consisting of sport exercises, physical therapy exercises, motion analysis exercises, dance exercises, musical training exercises, gait analysis, therapeutic exercises and diagnostic exercises.

22. The system of claim 22 further comprising a training program for said exercises.

23. A system for improving a person's physical motion performance comprising:
an electronic sensor, wherein said electronic sensor is attached to a moving body member of said person and captures motion parameters of said moving body member over time;
a computing device for receiving said motion parameters from said electronic sensor, converting said motion parameters into a graphical representation of said moving body member and displaying said graphical representation on a display screen in real time with said capturing of said motion parameters;
means for comparing said graphical representation of said moving body member with a graphical representation of an ideal standard of said physical motion in real time on said display screen and means for displaying results of said comparison on said display screen; and
means for providing real time feedback instructions to said person for improving said physical motion performance based on said comparison results.

24. A method for improving a person's physical motion performance comprising:
capturing a first set of visual images of said person's physical motion over time with a first equipment;
receiving a signal of said first set of visual images of said person's physical motion by a computing device, converting said first set of visual images into a graphical representation of said person's physical motion and displaying said graphical representation on a display screen in real time with said capturing of said first set of visual images;
comparing said graphical representation of said person's physical motion with a graphical representation of an ideal standard of said physical motion in real time on said display screen and displaying results of said comparison on said display screen; and
providing real time feedback instructions to said person for improving said physical motion performance based on said comparison results.

25. The method of claim 24 wherein said person's physical motion is selected from a group of physical motions consisting of whole body motion, motion of a body member and motion of a group of body members.

26. The method of claim 25 further comprising attaching an electronic sensor to a moving body member of said person, capturing motion parameters of said moving body member with said electronic sensor and transmitting said motion parameters to said computing device.

27. The method of claim 26 wherein said electronic sensors are selected from a group consisting of accelerometers, RF-sensors, active optical sensors, passive optical sensors, and magnetic sensors.

28. The method of claim 24 wherein said real time feedback is selected from a group consisting of spoken words and sentences, and sound with varying pitch and volume.

29. The method of claim 24 wherein said graphical representation of said person's physical motion is selected from a group consisting of a position coordinate graph, a position versus said time graph, a three-dimensional position coordinate graph, a velocity versus time graph, an acceleration versus time graph and a position graph overlaid onto a live video image.

30. The method of claim 24 further comprising capturing a second set of visual images of said person's physical motion over said time with a second equipment and wherein said computing device receives a signal of said second set of visual images and combines said second set visual image signal with said first set visual image signal and converts said combined first set and second set visual image signals into a graphical representation of said person's physical motion and displays said graphical representation on said display screen in real time with said capturing of said first set and second set of visual images.

31. The method of claim 30 wherein said computing device converts said combined first set and second set visual image signals into a graphical representation of said person's physical motion via triangulation.

32. The method of claim 31 wherein said first and said second equipment comprise a first and a second optical axis, respectively, and are arranged so that their corresponding first and second optical axes are at a known angle and said first and said second equipment are equidistant from said first and said second optical axes' intersection point.

33. The method of claim 32 wherein a three dimensional position coordinate graph comprises position coordinates of tracking points positioned on said person plotted in a three dimensional x-y-z Cartesian coordinate method and wherein said x-y-z Cartesian coordinate method comprises an origin located at said intersection point of said first and said second optical axes, an x-axis running parallel to a line joining said first and said second equipment, a y-axis running perpendicular to said line joining said first and said second equipment directly between said first and said second capturing equipment and a z-axis running vertical through said origin.

34. The method of claim 33 wherein the length of said line joining said first and said second equipment is used to scale and calculate said position coordinates in true distance units.

35. The method of claim 24 further comprising receiving a signal of said first set of visual images by a video controller, locating tracking points on said person and transmitting signals of said tracking points locations to said computing device.

36. The method of claim 35 wherein said tracking points comprise a bright color and said video controller locates said tracking points locations in said first set of visual images based on said bright color exceeding a set threshold level of brightness.

37. The method of claim 36 wherein said signals of said tracking points locations comprises average x-pixel position, average y-pixel position, average height, and average width.

38. The method of claim 25 wherein said computing device further comprises a tracking point locating algorithm for receiving said signal and locating tracking points on said person.

39. The method of claim 24 wherein said first set of visual images comprise motions of more than one person.

40. The method of claim 24 wherein said first capturing equipment is selected from a group consisting of a video camera, a video recorder, a NTSC camcorder, and a PAL camcorder.

41. The method of claim 24 wherein said computing device is selected from a group consisting of a personal computer, a notebook computer, a server, a computing circuit, and a personal digital assistant (PDA).

42. The method of claim 24 wherein said comparing comprises an application that displays simultaneously said physical motion graphical representation and said ideal standard of said physical motion and computes deviations between said physical motion graphical representation and said ideal standard of said physical motion.

43. The method of claim 24 wherein said real-time feedback is selected from a group consisting of audible feedback, visual feedback and sensory feedback.

44. The method of claim 24 wherein said physical motion is selected from a group consisting of sport exercises, physical therapy exercises, motion analysis exercises, dance exercises, musical training exercises, gait analysis, therapeutic exercises and diagnostic exercises.

45. The method of claim 44 further comprising a training program for said exercises.
